(19) United States
(12) Patent Application Publication
(10) Pub. No.: US 2025/0273883 A1
(43) Pub. Date: Aug. 28, 2025

(54) ALLIGATOR CLIP

(71) Applicant: HSIN TU TECHNOLOGY CO., LTD., Taichung City (TW)

(72) Inventor: Shou-Chun TSAI, Taichung City (TW)

(73) Assignee: HSIN TU TECHNOLOGY CO., LTD., Taichung City (TW)

(21) Appl. No.: 18/589,050

(22) Filed: Feb. 27, 2024

(51) Int. Cl. H01R 11/24; F16B 2/10; H01R 4/48

(52) U.S. Cl. CPC H01R 11/24; F16B 2/10; F16B 2200/93; H01R 4/4863

(57) ABSTRACT

An alligator clip has a clamping module and an insulating module. The clamping module has two clamping elements, an engaging portion, and an elastic element. The engaging structure is disposed between the two clamping elements to connect the two clamping elements with each other and has an engaging portion and a holding portion. The engaging portion is disposed on one of the two clamping elements and has a free end. The holding portion is disposed on the other one of the two clamping elements and engages with the free end of the engaging portion. The elastic element is disposed between the two clamping elements, abuts against the two clamping elements, and is disposed adjacent to the engaging structure. The insulating module is connected to the clamping module and has two outer covers respectively connected to the two clamping elements.

### BACKGROUND OF THE INVENTION

### 1. Field of the Invention

The present invention relates to a clamp, and more particularly to an alligator clip that has a simplified structure, can be assembled easily, and can save cost.

### 2. Description of Related Art

With reference to FIGS. 12 and 13, a conventional alligator clip 40 has a clamping module 41 and an insulating module 42. The clamping module 41 has two clamping elements 43 and a torsion spring 44. The two clamping elements 43 are connected to each other by a pivot shaft 45 and are moved toward or away from each other by using the pivot shaft 45 as a fulcrum. The torsion spring 44 is disposed between the two clamping elements 43 and abuts against the two clamping elements 43 to enable two ends of the two clamping elements 43 to remain in a state of contacting. Furthermore, the pivot shaft 45 passes through the torsion spring 44 and is connected to the two clamping elements 43 to form the clamping module 41 as an axial type clamping module. The insulating module 42 is connected to the clamping module 41 and has two outer covers 46 respectively connected to the two clamping elements 43 to provide an insulation effect. Then the conventional alligator clip 40 can be used to conduct electricity or signals.

However, with reference to FIGS. 12 and 14, when assembling the conventional alligator clip 40, since the two outer covers 46 are respectively mounted on the two clamping elements 43 to cover the two clamping elements 43, if the two outer covers 46 are connected to the two clamping elements 43 first, the pivot shaft 45 cannot pass through the two clamping elements 43. Therefore, with reference to FIG. 15, when assembling the conventional alligator clip 40, the pivot shaft 45 is passed through the two clamping elements 43 and the torsion spring 44 first and is riveted to hold the torsion spring 44 between the two clamping elements 43. Furthermore, during assembly, in order to enable the two ends of the two clamping elements 43 to abut against each other, the torsion spring 44 is pressed against by the two clamping elements 43. At this time, on one end, it is necessary to pass the pivot shaft 45 through the two clamping elements 43 and the torsion spring 44, on the other end, it is necessary to press against the torsion spring 44 by the two clamping elements 43, and this will increase time and inconvenience required for assembly.

Additionally, after assembling the clamping module 41, the two outer covers 46 are respectively connected to the two clamping elements 43. In order to avoid the two outer covers 46 separating from the two clamping elements 43 while the conventional alligator clip 40 is in use, the two outer covers 46 are securely connected to the two clamping elements 43 by hot melting. The hot melting is performed via inner sides of the two clamping elements 43 with the two outer covers 46, and the two ends of the two clamping elements 43 need to be opened by a fixture, and this will increase time required for assembly and require expenses to buy the fixture to open the two clamping elements 43 and will increase cost for assembling the conventional alligator clip 40. Therefore, the conventional alligator clip 40 needs to be improved.

The alligator clip in accordance with the present invention mitigates or obviates the aforementioned problems.

### SUMMARY OF THE INVENTION

The main objective of the present invention is to provide an alligator clip that has a simplified structure, can be assembled easily, and can save cost.

The alligator clip in accordance with the present invention has a clamping module and an insulating module. The clamping module has two clamping elements, an engaging portion, and an elastic element. The engaging structure is disposed between the two clamping elements to connect the two clamping elements with each other and has an engaging portion and a holding portion. The engaging portion is disposed on one of the two clamping elements and has a free end. The holding portion is disposed on the other one of the two clamping elements and engages with the free end of the engaging portion. The elastic element is disposed between the two clamping elements, abuts against the two clamping elements, and is disposed adjacent to the engaging structure. The insulating module is connected to the clamping module and has two outer covers respectively connected to the two clamping elements.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an alligator clip in accordance with the present invention;

FIG. 2 is a top exploded perspective view of the alligator clip in FIG. 1;

FIG. 3 is a bottom exploded perspective view of the alligator clip in FIG. 1;

FIG. 4 is an enlarged cross-sectional side view of the alligator clip in FIG. 1;

FIG. 5 is another enlarged cross sectional side view of the alligator clip in FIG. 1;

FIG. 6 is a perspective view of a clamping module of the alligator clip in FIG. 1;

FIG. 7 is an enlarged perspective view in partial section of the clamping module of the alligator clip in FIG. 6, omitting an elastic element;

FIG. 8 is an enlarged cross-sectional side view of the clamping module of the alligator clip in FIG. 6, omitting the elastic element;

FIG. 9 is an operational cross-sectional side view of the alligator clip in FIG. 1;

FIG. 10 is an operational perspective view of the clamping module of the alligator clip in FIG. 1;

FIG. 11 is an operational perspective view in partial section of the clamping module of the alligator clip in FIG. 1, omitting the elastic element;

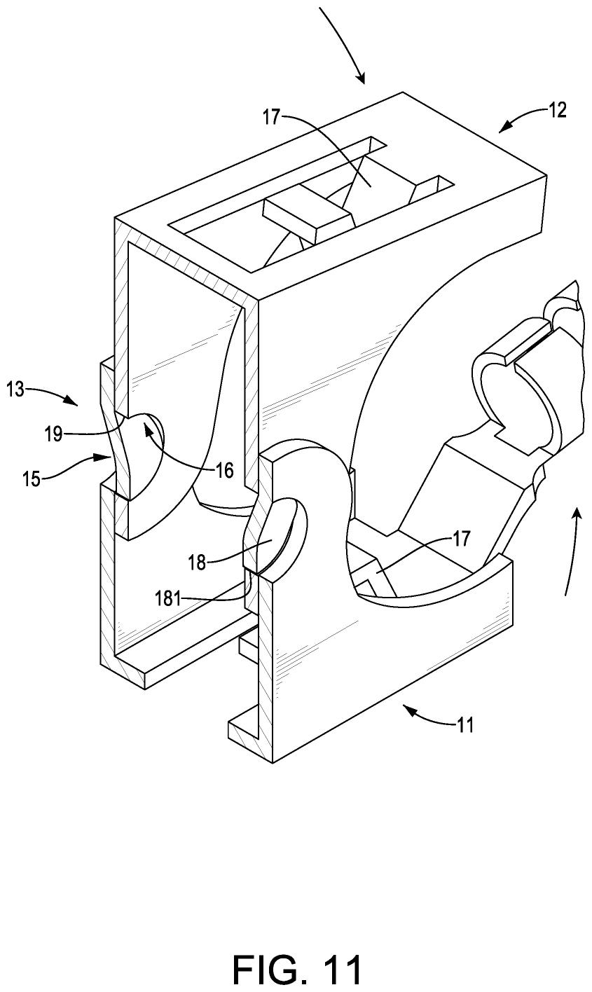

FIG. 12 is an exploded perspective view of an alligator clip in accordance with the prior art;

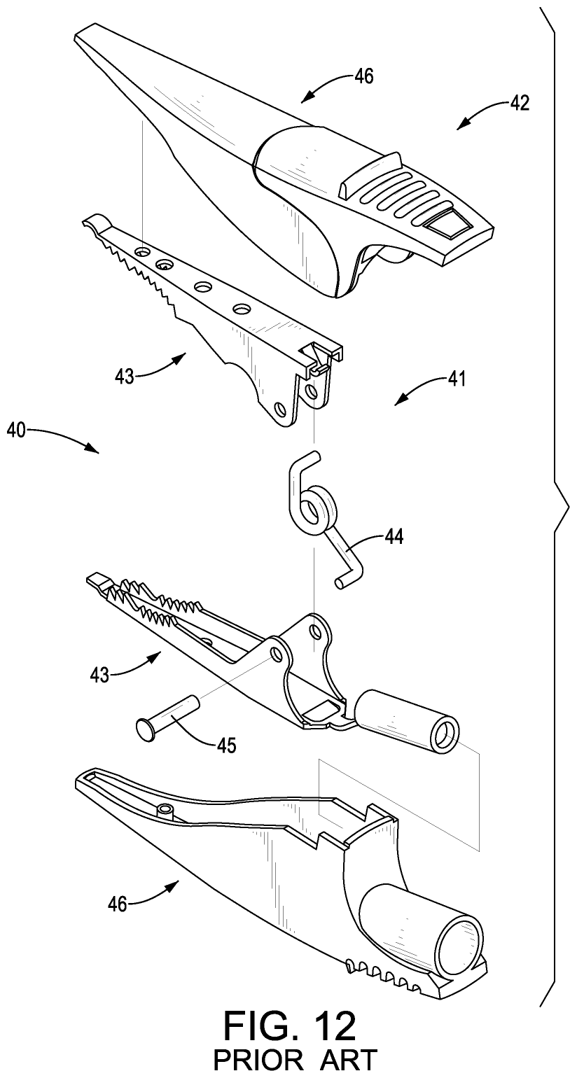

FIG. 13 is a perspective view of a clamping module of the alligator clip in FIG. 12;

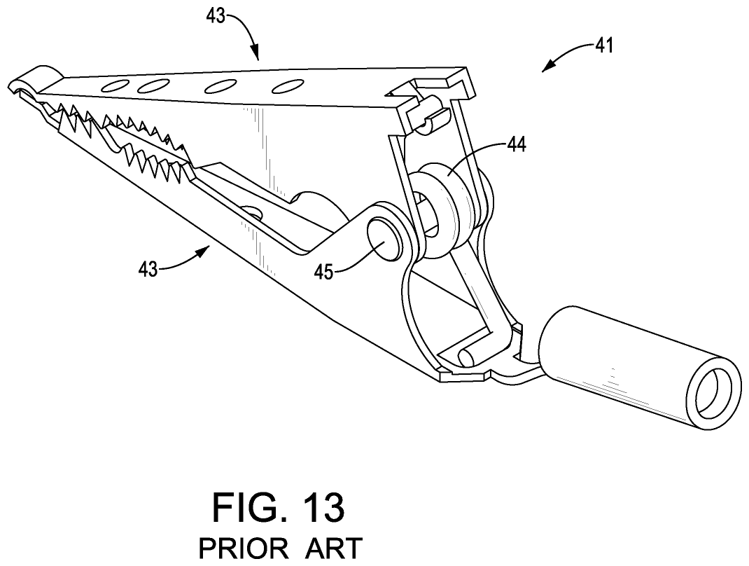

FIG. 14 is a side view in partial section of the clamping module of the alligator clip in FIG. 13; and

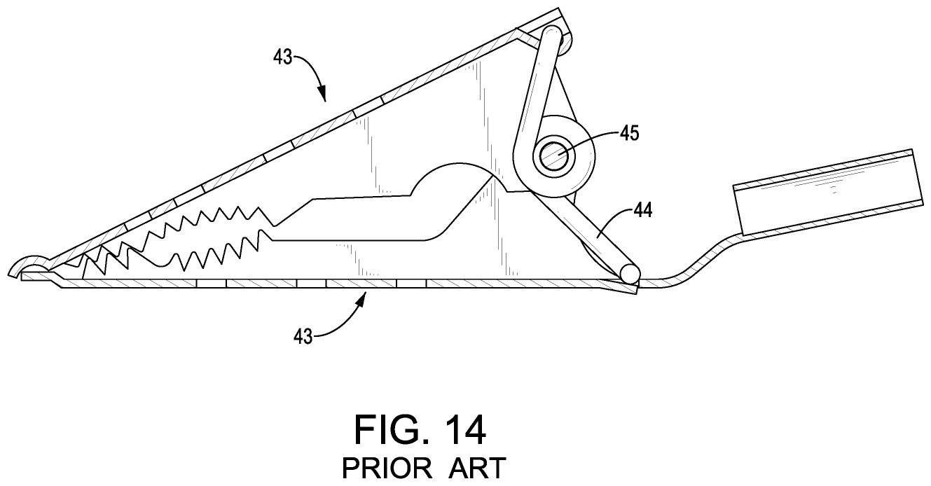

FIG. 15 is an enlarged side view in partial section of the clamping module of the alligator clip in FIG. 13.

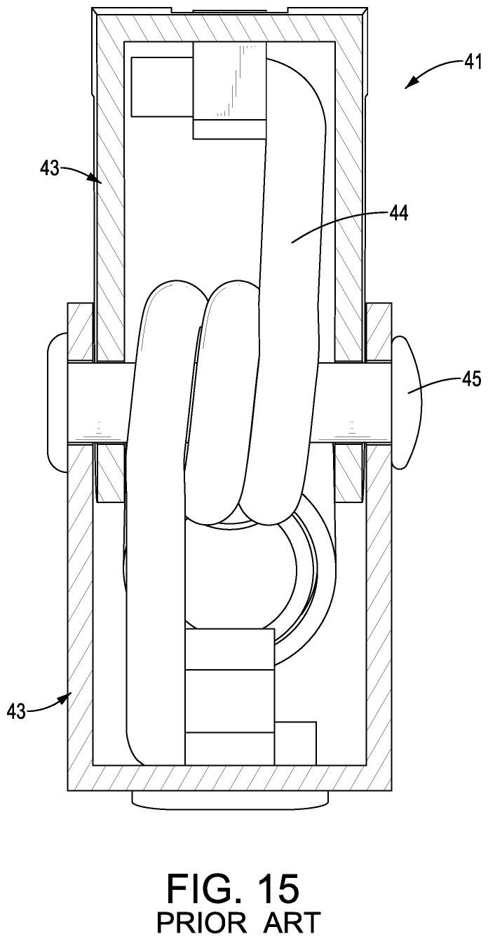

### DETAILED DESCRIPTION OF THE PREFERRED EMBODIMENT

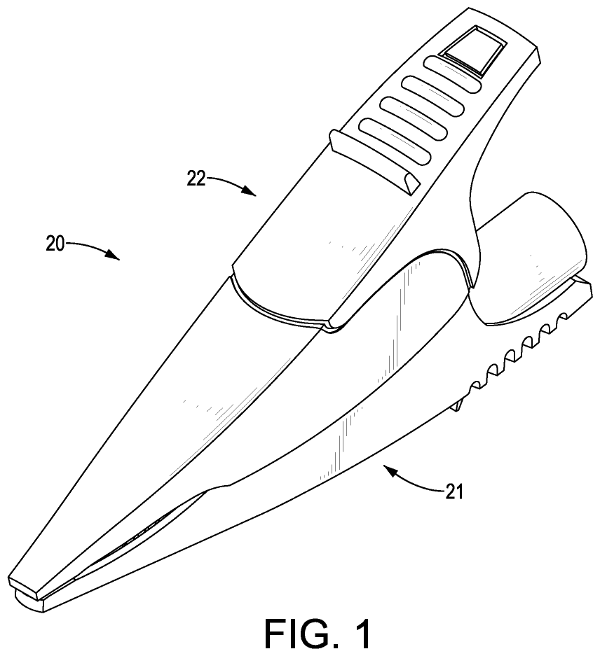

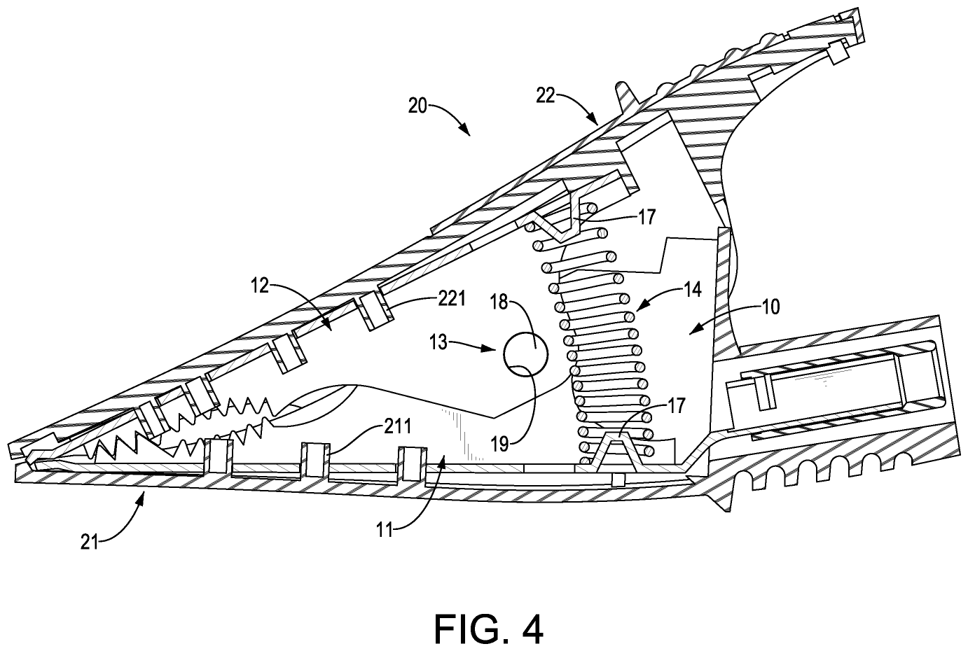

With reference to FIGS. 1 to 4, an alligator clip in accordance with the present invention has a clamping module 10 and an insulating module 20.

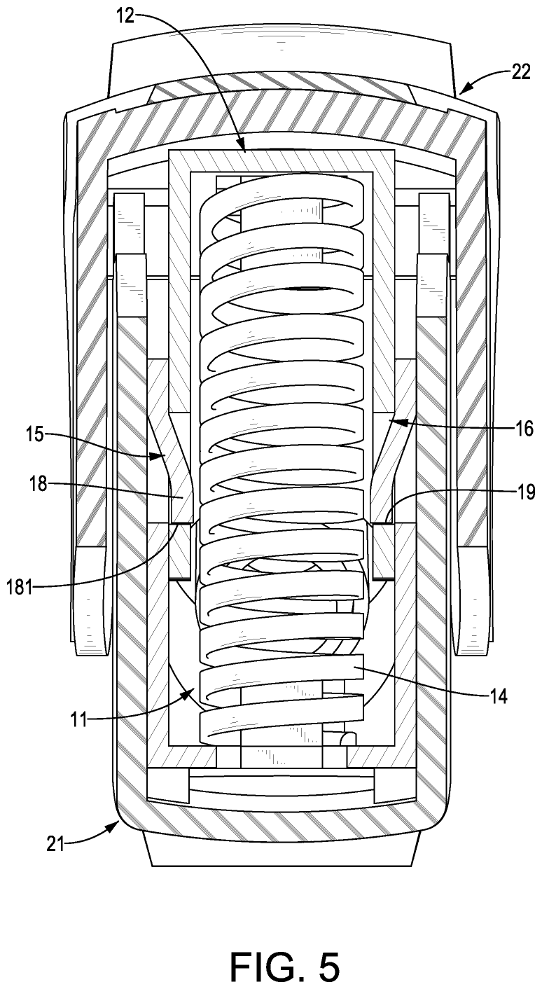

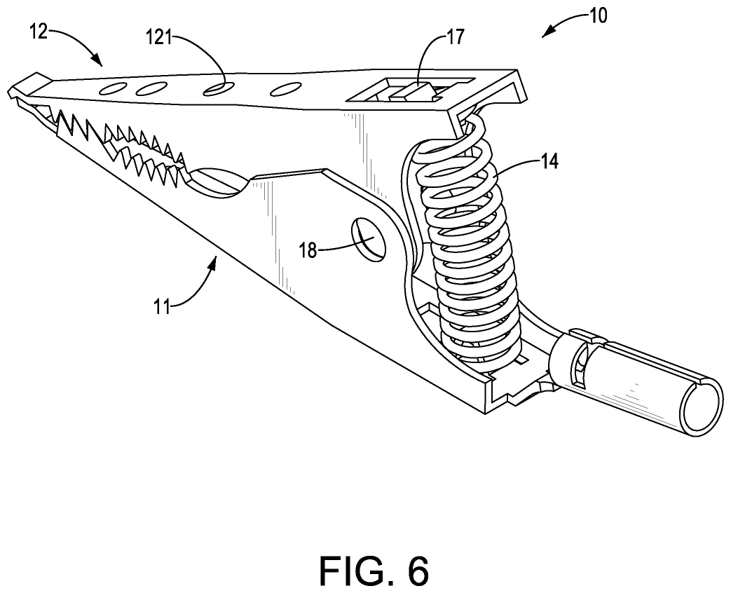

With reference to FIGS. 5 and 6, the clamping module 10 has two clamping elements, an engaging structure 13, and an elastic element 14. The two clamping elements, respectively a first clamping element 11 and a second clamping element 12, are made of a conductive material and are pivotally connected to each other. The engaging structure 13 is disposed between the first clamping element 11 and the second clamping element 12 to connect the second clamping element 12 with the first clamping element 11. The engaging structure 13 has an engaging portion 15 and a holding portion 16. The engaging portion 15 is disposed on one of the first clamping element 11 and the second clamping element 12 and has a free end, and the holding portion 16 is disposed on the other one of the first clamping element 11 and the second clamping element 12 and engages with the free end of the engaging portion 15.

The elastic element 14 is disposed between the first clamping element 11 and the second clamping element 12, abuts against the first clamping element 11 and the second clamping element 12, and is disposed adjacent to the engaging structure 13. The first clamping element 11 and the second clamping element 12 are pushed by the elastic element 14 to enable two ends of the first clamping element 11 and the second clamping element 12 away from the elastic element 14 to abut each other.

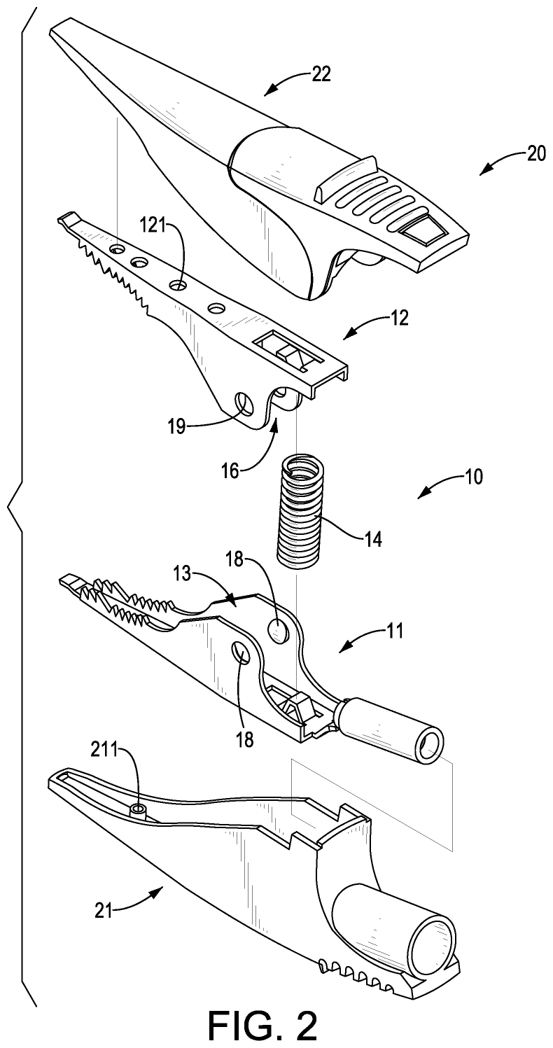

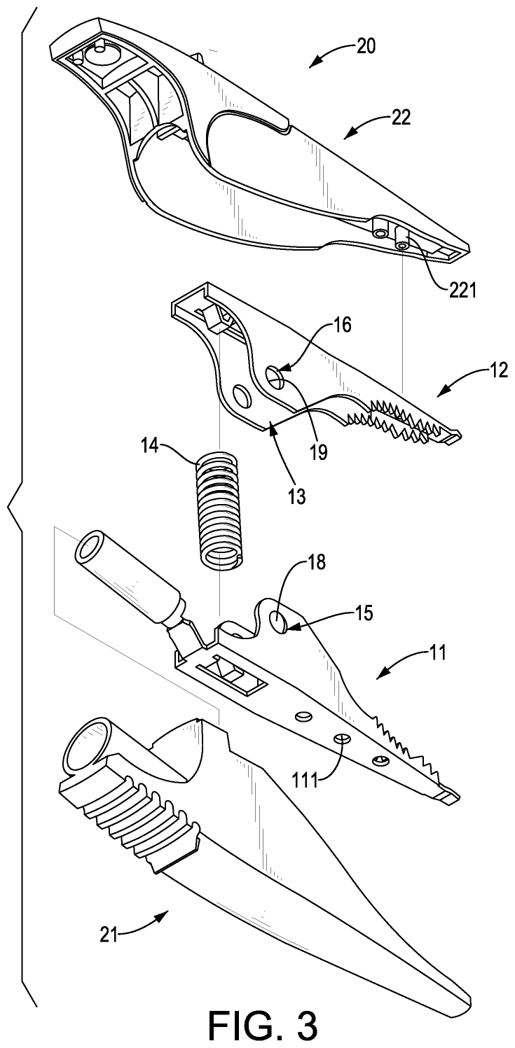

Furthermore, each one of the first clamping element 11 and the second clamping element 12 has a connecting protrusion 17 disposed on an inner side of the clamping element, and two ends of the elastic element 14 are respectively mounted on the two connecting protrusions 17 of the first clamping element 11 and the second clamping element 12. Then the elastic element 14 is stably disposed between the first clamping element 11 and the second clamping element 12. Preferably, the elastic element 14 may be a compressed spring. Additionally, with reference to FIGS. 2 and 3, each one of the first clamping element 11 and the second clamping element 12 has multiple assembling holes 111, 121 formed through the clamping element at spaced intervals.

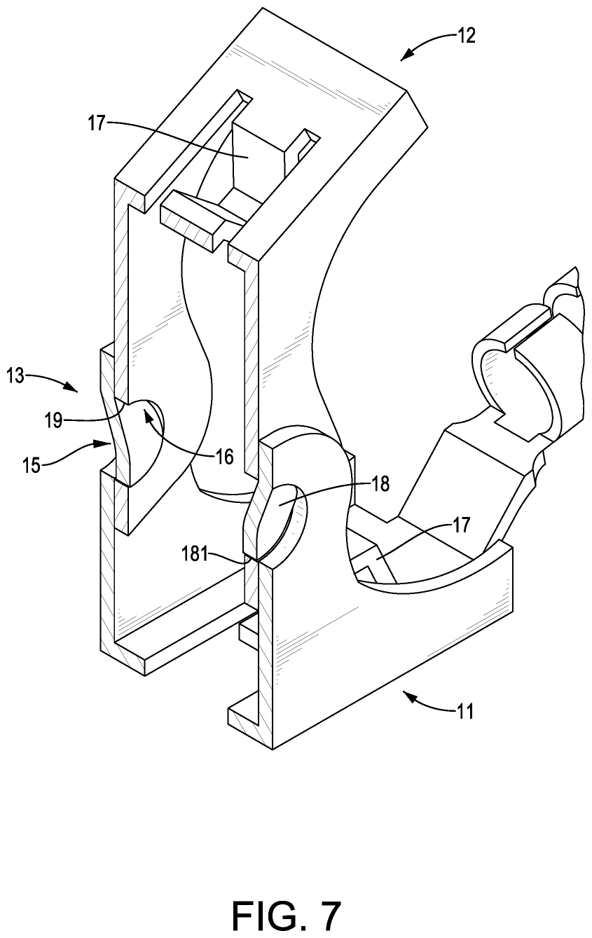

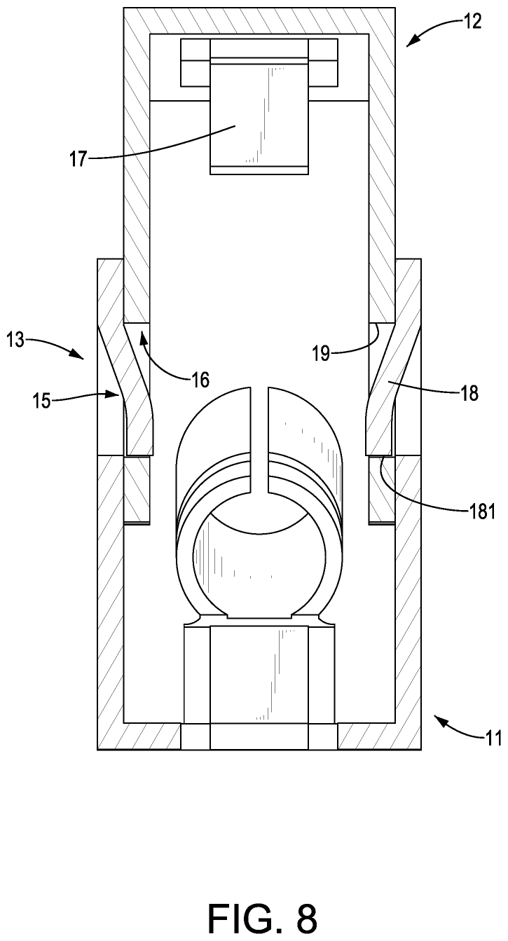

Preferably, with reference to FIGS. 7 and 8, the engaging portion 15 of the engaging structure 13 is disposed on the first clamping element 11 and is formed by two engaging panels 18. The two engaging panels 18 are disposed on the first clamping element 11 at a spaced interval by stamping and are elastically deformable. Each one of the two engaging panels 18 has an engaging end 181, and the two engaging ends 181 of the two engaging panels 18 form the free end of the engaging portion 15. The holding portion 16 of the engaging structure 13 is disposed on the second clamping element 12 and is formed by two engaging holes 19. The two engaging holes 19 are disposed on the second clamping element 12 at a spaced interval by stamping and respectively engage with the two engaging panels 18. Each one of the two engaging holes 19 has an inner surface abutted against the engaging end 181 of a corresponding one of the two engaging panels 18. Then the first clamping element 11 and the second clamping element 12 are pivotally connected to each other by the two engaging panels 18 respectively engaging in the two engaging holes 19 without using a pivot shaft to form the clamping module 10 as a shaftless clamping module.

Furthermore, the locations of the engaging portion 15 and the holding portion 16 of the engaging structure 13 can be exchanged with each other, i.e., the engaging portion 15 is disposed on the second clamping element 12, and the holding portion 16 is disposed on the first clamping element 11, as long as the holding portion 16 engages with the engaging portion 15.

With reference to FIGS. 2 to 5, the insulating module 20 is connected to the clamping module 10 and has two outer covers. The two outer covers, respectively a first outer cover 21 and a second outer cover 22, are made of an insulating material, and are respectively connected to the first clamping element 11 and the second clamping element 12. Each one of the first outer cover 21 and the second outer cover 22 has multiple assembling tubes 211, 221. The multiple assembling tubes 211, 221 of each one of the two outer covers are formed on and protruded from an inner side of the outer cover and are respectively extended through the multiple assembling holes 111, 121 of a corresponding one of the two clamping elements. When the two outer covers are respectively connected to the two clamping elements, a hot melting method is used to connect the two outer covers securely with the two clamping elements. Preferably, the first outer cover 21 is securely connected to the first clamping element 11, and the second outer cover 22 is securely connected to the second clamping element 12.

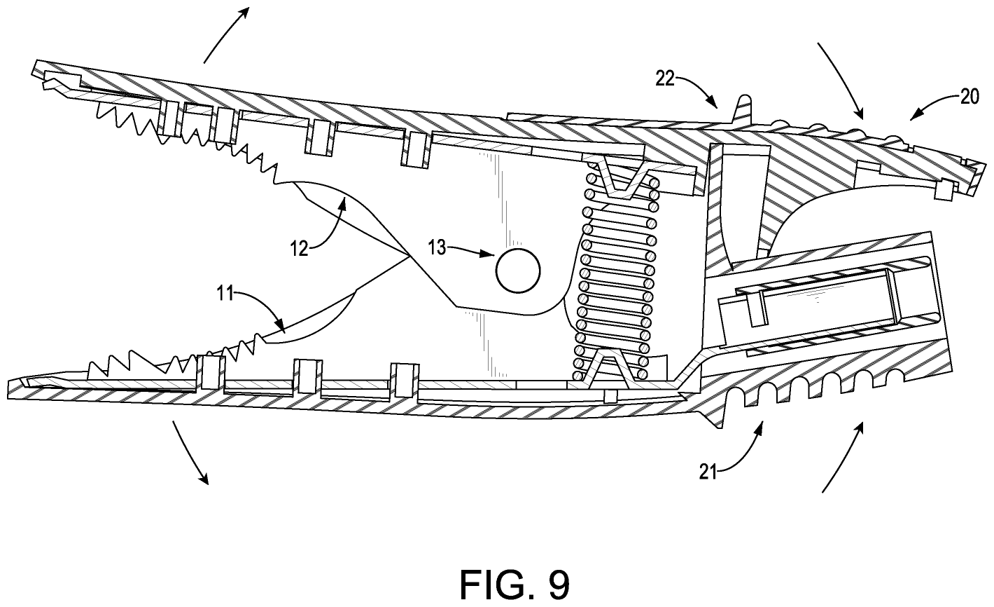

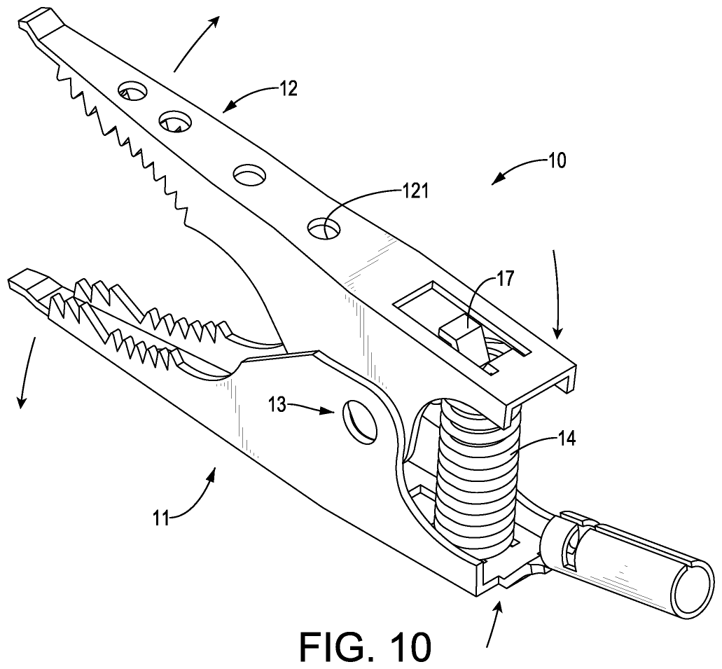

With reference to FIGS. 9 and 10, when the alligator clip of the present invention is in use, pressing the first outer cover 21 and the second outer cover 22 to enable the first clamping element 11 and the second clamping element 12 to move relative to each other by using the engaging structure 13 as a fulcrum to compress the elastic element 14. Then the two ends of the first clamping element 11 and the second clamping element 12 away from the elastic element 14 are moved away from each other. At this time, moving the alligator clip of the present invention adjacent an electrical wire or a signal line and releasing to press the first outer cover 21 and the second outer cover 22, and the compressed elastic element 14 will push the first clamping element 11 and the second clamping element 12 to move to enable the two ends of the first clamping element 11 and the second clamping element 12 to move toward each other to clamp the electrical wire or the signal line. After using the alligator clip of the present invention, a user only needs to press the first outer cover 21 and the second outer cover 22 again to separate the first clamping element 11 and the second clamping element 12 from the electrical wire or the signal line.

With further reference to FIGS. 2 and 3, to assemble the alligator clip of the present invention, since the first clamping element 11 and the second clamping element 12 can be connected with each other without using a pivot shaft, the first outer cover 21 and the second outer cover 22 can respectively and securely connect to the first clamping element 11 and the second clamping element 12 by hot melting, firstly. After the first outer cover 21 and the second outer cover 22 are securely connected to the first clamping element 11 and the second clamping element 12, the elastic element 14 is disposed between the two connecting protrusions 17 of the first clamping element 11 and the second clamping element 12. At this time, with reference to FIG. 5, moving the second clamping element 12 toward the first clamping element 11 enables the two engaging ends 181 of the engaging panels 18 of the engaging portion 15 to respectively engage in the two engaging holes 19 of the holding portion 16 to complete the assembly of the alligator clip of the present invention, and this is convenient in assembly, can save time of assembly, and there is no need to buy a fixture to open the first clamping element 11 and the second clamping element 12, reducing cost of using the alligator clip. Therefore, the present invention provides an alligator clip that has a simplified structure, can be assembled easily, and can save cost.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An alligator clip comprising:
a clamping module having
two clamping elements;
an engaging structure disposed between the two clamping elements to connect the two clamping elements with each other and having
an engaging portion disposed on one of the two clamping elements and having a free end; and
a holding portion disposed on the other one of the two clamping elements and engaging with the free end of the engaging portion; and
an elastic element disposed between the two clamping elements, abutted against the two clamping elements, and disposed adjacent to the engaging structure; and
an insulating module connected to the clamping module and having two outer covers respectively connected to the two clamping elements.

2. The alligator clip as claimed in claim 1, wherein
the engaging portion of the engaging structure is formed by two engaging panels;
the two engaging panels are disposed on one of the two clamping elements at a spaced interval and are elastically deformable;
each one of the two engaging panels has an engaging end, and the two engaging ends of the two engaging panels form the free end of the engaging portion;
the holding portion of the engaging structure is formed by two engaging holes;
the two engaging holes are disposed on the other one of the two clamping elements at a spaced interval and respectively engage with the two engaging panels; and
each one of the two engaging holes has an inner surface abutted against the engaging end of a corresponding one of the two engaging panels.

3. The alligator clip as claimed in claim 2, wherein
each one of the two clamping elements has multiple assembling holes formed through the clamping element at spaced intervals; and
each one of the two outer covers has multiple assembling tubes formed on and protruded from an inner side of the outer cover and respectively extended through the multiple assembling holes of a corresponding one of the two clamping elements.

4. The alligator clip as claimed in claim 2, wherein
the two clamping elements are respectively a first clamping element and a second clamping element;
the two outer covers are respectively a first outer cover and a second outer cover; and
the first outer cover is connected to the first clamping element and the second outer cover is connected to the second clamping element.

5. The alligator clip as claimed in claim 3, wherein
the two clamping elements are respectively a first clamping element and a second clamping element;
the two outer covers are respectively a first outer cover and a second outer cover; and
the first outer cover is connected to the first clamping element and the second outer cover is connected to the second clamping element.

6. The alligator clip as claimed in claim 4, wherein
each one of the two clamping elements has a connecting protrusion disposed on an inner side of the clamping element; and
the elastic element has two ends respectively mounted on the connecting protrusions of the two clamping elements.

7. The alligator clip as claimed in claim 5, wherein
each one of the two clamping elements has a connecting protrusion disposed on an inner side of the clamping element; and
the elastic element has two ends respectively mounted on the connecting protrusions of the two clamping elements.

8. The alligator clip as claimed in claim 1, wherein the elastic element is a compressed spring.

9. The alligator clip as claimed in claim 2, wherein the elastic element is a compressed spring.

10. The alligator clip as claimed in claim 3, wherein the elastic element is a compressed spring.

11. The alligator clip as claimed in claim 1, wherein
the two clamping elements are respectively a first clamping element and a second clamping element;
the two outer covers are respectively a first outer cover and a second outer cover; and
the first outer cover is connected to the first clamping element and the second outer cover is connected to the second clamping element.

12. The alligator clip as claimed in claim 11, wherein
the engaging portion of the engaging structure is formed by two engaging panels;
the two engaging panels are disposed on one of the two clamping elements at a spaced interval and are elastically deformable;
each one of the two engaging panels has an engaging end, and the two engaging ends of the two engaging panels form the free end of the engaging portion;
the holding portion of the engaging structure is formed by two engaging holes;
the two engaging holes are disposed on the other one of the two clamping elements at a spaced interval and respectively engage with the two engaging panels; and
each one of the two engaging holes has an inner surface abutted against the engaging end of a corresponding one of the two engaging panels.

13. The alligator clip as claimed in claim 11, wherein
each one of the two clamping elements has multiple assembling holes formed through the clamping element at spaced intervals; and
each one of the two outer covers has multiple assembling tubes formed on and protruded from an inner side of the outer cover and respectively extended through the multiple assembling holes of a corresponding one of the two clamping elements.

14. The alligator clip as claimed in claim 12, wherein
each one of the two clamping elements has multiple assembling holes formed through the clamping element at spaced intervals; and
each one of the two outer covers has multiple assembling tubes formed on and protruded from an inner side of the outer cover and respectively extended through the multiple assembling holes of a corresponding one of the two clamping elements.

15. The alligator clip as claimed in claim 13, wherein the elastic element is a compressed spring.

16. The alligator clip as claimed in claim 14, wherein the elastic element is a compressed spring.
